(19) United States
(12) Patent Application Publication
(10) Pub. No.: US 2004/0203610 A1
(43) Pub. Date: Oct. 14, 2004

(54) Creating and transmitting a text message from a terminal

(76) Inventor: Douglas Deeds, Fort Worth, TX (US)

Correspondence Address: STEVEN A. SHAW, NOKIA, INC., 6000 CONNECTION DRIVE, MD 1-4-755, IRVING, TX, 75039, US

(21) Appl. No.: 10/132,539

(22) Filed: Apr. 25, 2002

(51) Int. Cl. H04M 11/10; H04Q 7/20; H04M 1/00; H04B 1/38

(52) U.S. Cl. 455/412.1; 455/466; 455/564

(57) ABSTRACT

A terminal adapted to communicate via a communications system includes a keypad having a plurality of keys, where at least one key is associated with at least one directory entry that includes at least one location identifier. The terminal includes a controller capable of executing a text editor in response to actuation of the key(s) associated with an entry, and thereafter receiving a text message into the text editor. The terminal also includes a transmitter for transmitting the text message to a destination identified by the location identifier associated with entry associated with the key(s). The controller can receive a text query that is transmitted to information processing element associated with the key(s) to thereby execute a search based upon the text query.

### BACKGROUND

The present invention relates generally to terminals such as mobile telephones and, more particularly, relates to creating and transmitting a message, such as a text message or a text query, from a terminal to an entry in a database based upon actuation of a relatively small number of keys that have been previously associated with the entry.

A conventional terminal, such as a mobile telephone—also known as a mobile stations, includes a keypad having alphanumeric keys by means of which a user can enter a telephone number, write a text message (SMS), write a name associated with a telephone number and input other information into the telephone. Each key is generally provided with a number “0-9” or a sign “#” or “*” often used in text editing. In alpha mode, each key is associated with a group of letters or special signs to enable text input.

It has become desirable to improve the speed at which the functions of a mobile telephone can be activated and in which information, especially text, can be input. In a conventional mobile telephone, composing and thereafter transmitting a text message is a slow process as the user must select a text editor, enter a text message and thereafter enter parameters by which the text message is sent, such as the phone number to which the text message is sent. For example, aside from the number of key presses required to enter the text message, to compose a text message and thereafter transmit the text message from a telephone having a conventional keypad typically requires a total of 10 or more separate key presses, i.e. two softkey presses are required to display a menu from a main display and thereafter select the messages option from the menu; two softkey presses are required to select a write option and thereafter select an option to enter the text message; three or more softkey presses are required to select to send the message and thereafter search or enter a number to which the message is to be sent; and three softkey presses are required to confirm the number, and thereafter return to the main display.

Techniques have been developed to improve the speed with which the text itself may be entered. One such technique has been presented in U.S. patent application Ser. No. 09/932,632 entitled: Electronic Device, filed Aug. 17, 2001 and published as U.S. Publication No. 2002/0028697. As disclosed in the '632 application, the speed at which the actual text is input can be improved by storing different text strings in memory and assigning the text strings to keys such that the text strings can be recalled from memory in response to operating the respective keys for a predetermined time period. For example, the word “Wednesday” can be stored in memory and assigned to the key (8) such, that while in the text editor, the word “Wednesday” can be recalled and entered into the text editor upon depressing the key (8) for a predetermined time period. While such techniques accelerate the rate at which text may be entered, the process required to access the text editor and then send the text message remain cumbersome.

In addition to the text entry problems mentioned above, when the message comprises a text query, the process of receiving a response from the text query is also generally a slow process. In this regard, there is a new generation of mobile telephones that can be used to access the internet such as the WAP (wireless application protocol) telephones. This is an industry specification agreed upon by most of the major telephone manufacturers and service providers that allows a WAP enabled mobile telephone, pager or personal data assistant owner to access the Internet, effectively turning such devices into Web browsers. But due to slow network interconnection speeds and somewhat clumsy user interfaces (i.e., browsers), typically including multiple pages of menus and text, WAP is not generally utilized by a sizeable portion of mobile telephone users. As such, the time required to enter a text query and to receive a response is often more than many mobile telephone users are willing to undertake.

It is known for mobile telephones to include a directory stored in memory that includes names and associated location identifiers, such as such as mobile telephone numbers, landline telephone numbers, SMS numbers, pager numbers, facsimile numbers, instant messaging addresses and/or electronic mail (E-mail) addresses. It is also known to improve the speed at which the mobile telephone can be activated to dial a selected telephone number from the directory by associating the selected telephone number, or the name associated with the selected telephone number, with one or more keys. The mobile telephone can then “speed” dial the selected telephone number by depressing or otherwise actuating the keys associated with the selected telephone number or name. In this regard, the number of keys associated with the telephone number (e.g., two keys) generally numbers less than the number of keys required to enter the telephone number (e.g., seven or ten keys) or otherwise search and select the number from the directory (e.g., three or more keys).

While speed dialing provides one technique for improving the speed at which mobile telephones dial a selected number, such a method does not improve the speed at which mobile telephones can be activated and thereafter transmit text messages. In this regard, aside from various methods for improving the speed at which the text messages can be entered into the text editor, conventional mobile telephones do not presently provide a method of improving the speed at which a text editor can be accessed and the resulting text message can be thereafter transmitted, such as to an SMS number. Further, conventional mobile telephones do not presently provide a method of improving the speed at which the mobile telephones can be activated to compose and transmit text queries.

### SUMMARY

In light of the foregoing background, embodiments of the present invention provide an improved system, terminal and method of transmitting a text message from a terminal, which significantly reduces the overall number of keystrokes required to transmit the message. According to embodiments of the present invention, a text editor can be executed by depressing or otherwise actuating one or more keys of a keypad of the terminal. In turn, a text message can be entered into the text editor and thereafter transmitted to a destination identified by the location identifier (e.g., SMS number) of an entry associated with the key(s) actuated. As such, a text message can be composed and transmitted without separately entering or searching for the location identifier to which to send the text message, and without separately searching for the text editor among the various features of the terminal. Moreover, the text message can be a text query that is transmitted to an information processing element for performing a search of one or more databases. As such, the terminal can facilitate a user in composing a text query and transmitting the text query without requiring the query to be transmitted via slow network interconnection speeds, and without requiring use of the clumsy user interfaces of many network browsers. Therefore, the system, terminal and method of embodiments of the present invention solve the problems identified by prior techniques and provide additional advantages.

According to one embodiment, a terminal adapted to communicate via a communications system is provided. The terminal includes a keypad including a plurality of keys. Advantageously, at least one key is associated with at least one entry of a directory. Each entry preferably includes at least one location identifier. The terminal also includes a controller capable of executing a text editor in response to actuation of the key(s) associated with the entries. In this regard, the controller is capable of receiving a text message into the text editor. The terminal can also include a display capable of displaying the text editor and the text message. Additionally, the terminal also advantageously includes a transmitter capable of transmitting the text message to the destination identified by the location identifier associated with entry that has been selected by actuation of the key(s).

According to one embodiment, a directory entry associated with at least one key identifies the location identifier of a destination network element, such as an information processing element including, for example, a computer executing a software routine sometimes referred to as a “bot.” In this embodiment, the controller is capable of receiving a text query into the text editor in response to actuation of the key(s) associated with an information processing element. As such, the transmitter is capable of transmitting the text query to the designated information processing. Based upon the text query, the information processing element can execute a search of at least one database, and thereafter develop a response. To receive the response to the text query, the terminal can also include a receiver. To aid in executing the search, the text query can include at least one key word identifying a subject. The transmitter, then, can transmit the text query to the information processing element based upon the subject identified by the keywords, such that certain subject specific queries are directed to information processing elements dedicated to the particular subject.

According to another aspect of the present invention, a method of transmitting a text message from a terminal adapted to communicate via a communications system is presented. The method begins by actuating at least one key of the terminal. The key(s) are associated with a directory entry that includes at least one location identifier, such as an SMS number. In response to actuation of the key(s), a text editor is executed, and thereafter a text message is received into the text editor. After the text message is received, the text message is transmitted to the destination associated with the location identifier of the entry associated with the key(s) that were actuated. As such, the user of the terminal need not separately enter or otherwise search for a location identifier to which to send the text message.

When the text message comprises a text query, and the key(s) actuated are associated with an information processing element, the text query is transmitted to the information processing element associated with the key(s) that have been actuated. The information processing element can then search at least one database based upon the text query, and thereafter develop a response based upon the text query and the search, which is subsequently received and displayed by the terminal. As such, the terminal can initiate and transmit the text query without requiring the terminal to transmit the query via slow network interconnection speeds or using the clumsy user interfaces of many network browsers.

### BRIEF DESCRIPTION OF THE DRAWINGS

Having thus described the invention in general terms, reference will now be made to the accompanying drawings, which are not necessarily drawn to scale, and wherein:

FIG. 1A is a block diagram of a mobile communications system according to one embodiment of the present invention including a mobile station and a Base Station/MSC/Interworking function (BMI) to which the mobile station is bidirectionally coupled through wireless RF links;

FIG. 1B is a block diagram of a mobile communications system according to another embodiment of the present invention including a mobile station and the Base Station/MSC/Interworking function (BMI), where the BMI is bidirectionally coupled to a wide area network;

FIG. 2 is a schematic diagram of a mobile station according to one embodiment of the present invention;

FIG. 3 is a flowchart illustrating various steps in a method of creating entries in a telephone directory of a mobile station according to one embodiment of the present invention;

FIG. 4 is a flowchart illustrating various steps in a method of associating one or more entries with one or more keys to thereby configure one or more entries for speed dialing according to one embodiment of the present invention;

FIG. 5 is a flowchart illustrating various steps in a method of associating one or more entries with one or more keys to thereby configure one or more entries for quick messaging or quick querying according to one embodiment of the present invention;

FIGS. 6A-6C are flowcharts illustrating various steps in a method of transmitting a text message utilizing quick messaging according to one embodiment of the present invention; and

FIGS. 7A-7C are flowcharts illustrating various steps in a method of transmitting a text query utilizing quick querying according to one embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

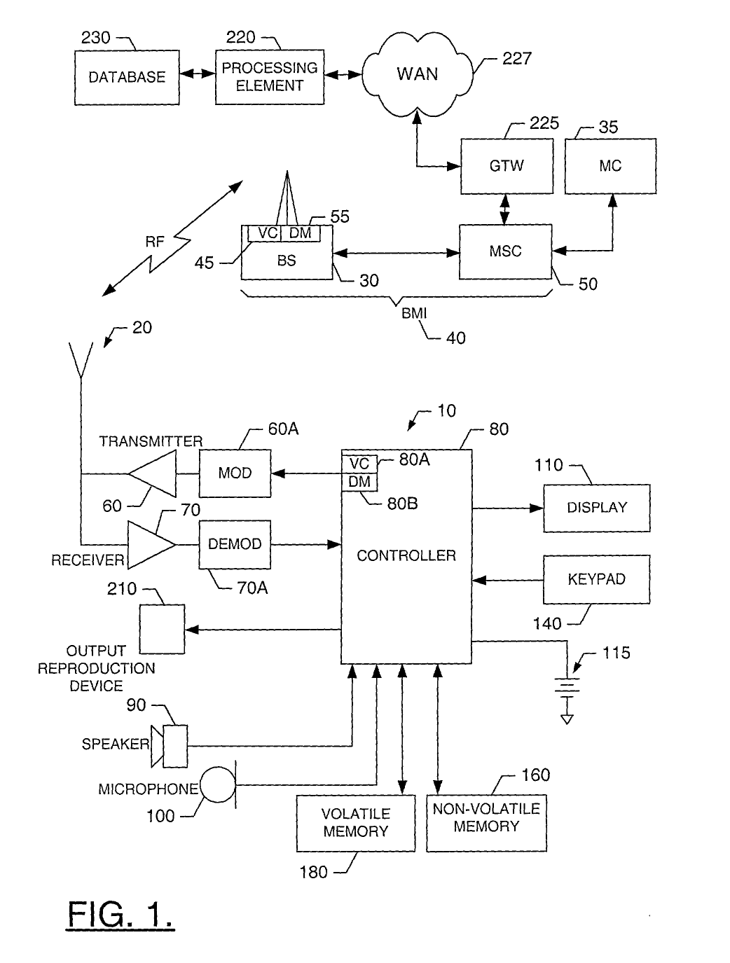

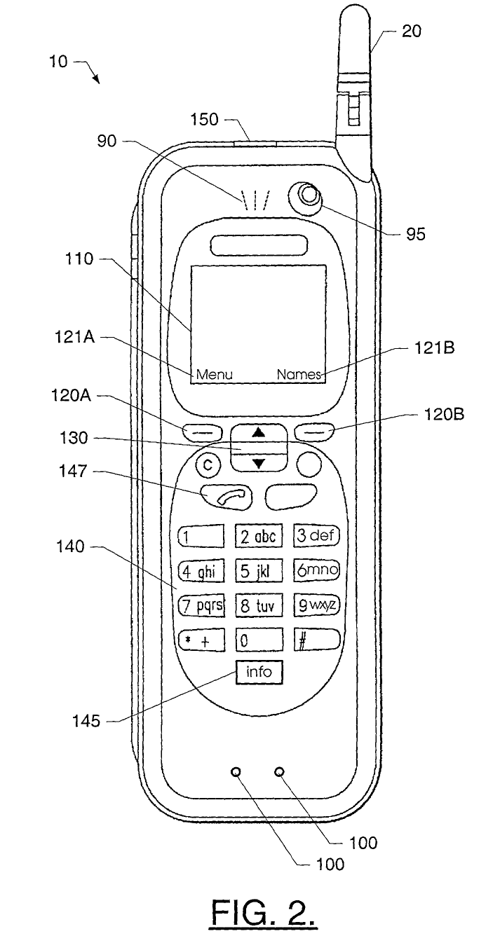

Referring to FIGS. 1 and 2, an illustration of one type of terminal, a mobile station, that would benefit from the present invention is provided. It should be understood, however, that the mobile telephone illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of terminals can readily employ the present invention. Moreover, the system, terminal and method of the present invention will be primarily described in conjunction with mobile communications applications. But the system, terminal and method of the present invention can be utilized in conjunction with a variety of other applications, both in the mobile communications industries and outside of the mobile communications industries.

In general, the method in accordance with an embodiment of the present invention applies to any terminal, such as any landline telephone, mobile telephone, radiotelephone, pager user terminal, or personal communicator, that is capable of sending a message, and that includes a display for displaying the message to a user. Also, the method of the present invention applies to any terminal, such as any landline telephone, mobile telephone, radiotelephone, pager user terminal, or personal communicator, that includes a user input device, such as a keypad, with which the user can manually generate messages and also interact with a displayed menu to select various mobile station functions and to input data. It should thus be clear that the method in accordance with an embodiment of the present invention is not to be construed to be limited to any one particular type of terminal, communication interface standard, or communication protocol.

As shown, the mobile station 10 includes an antenna 20 for transmitting signals to and for receiving signals from a base site or base station (BS) 30. The base station is a part of a cellular network that includes a mobile switching center (MSC) 50, a message center (MC) 35, voice coder/decoders (vocoders) (VC) 45, data modems (DM) 55, and other units required to operate the network. The MSC is capable of routing calls and messages to and from the mobile station when the mobile station is making and receiving calls. As indicated above, the cellular network may also be referred to as a Base Station/MSC/Interworking function (BMI) 40. The MSC controls the forwarding of messages to and from the mobile station when the station is registered with the network, and also controls the forwarding of messages for the mobile station to and from the MC. Such messages may include, for example, voice messages received by the MSC from users of Public Switched Telephone Network (PSTN) telephones (not shown), and may also include Short Message Service (SMS) messages and voice messages received by the MSC from the mobile station or other mobile terminals (not shown) serviced by the network.

It is assumed for the purposes of this invention that the MC 35 has a capability for converting SMS messages originating from the mobile station 10 to electronic mail (E-mail) messages, page messages, or facsimile messages, for cases in which the SMS messages include a command specifying that the messages be converted to these respective message types. It is also assumed for the purposes of this invention that the network supports data services and can be coupled to a data network such as a local area network (LAN) and/or to a wide area network (WAN) such as the Internet. Furthermore, it is assumed that the MSC forwards data, including facsimile and electronic mail (E-mail) messages, to destination devices such as, e.g., destination CPUs and facsimile devices (not shown), via the data network.

The mobile station includes a modulator (MOD) 60A, a transmitter 60, a receiver 70, a demodulator (DEMOD) 70A, and a controller 80 that provides signals to and receives signals from the transmitter and receiver, respectively. These signals include signaling information in accordance with the air interface standard of the applicable cellular system, and also user speech and/or user generated data. The air interface standard is assumed for this invention to include SMS capability, one suitable type of Teleservices capability is defined in the current version of the IS-136 wireless communication protocol.

It is understood that the mobile station 10 can be a vehicle mounted or a handheld device. It should be further appreciated that the mobile station can be capable of operating with one or more air interface standards, communication protocols, modulation types, and access types. For example, the mobile station may be capable of operating in accordance with wireless communication protocols IS-136, GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

As stated, the mobile station 10 can be coupled to a data network. In this regard, the mobile services switching center MSC 50 can be connected to a server GTW 225 (Gateway), which is in connection with a WAN 227, such as the Internet. In turn, other devices can be connected to the WAN, such as processing elements 220 (e.g., personal computers, server computers or the like) and associated databases 230, one of each being illustrated in FIG. 1. By directly or indirectly connecting both the mobile station and the other devices to the WAN, the mobile station can communicate with the other devices, such as according to the wireless application protocol (WAP) specification, to thereby carry out various functions of the mobile station.

It is understood that the controller 80 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 80A, and may include an internal data modem (DM) 80B.

The mobile station 10 also comprises a user interface including a conventional earphone or speaker 90, a ringer 95, a conventional microphone 100, a display 110, and a user input interface, all of which are coupled to the controller 80. The mobile station also includes a battery 115, such as a vibrating battery pack, for powering the various circuits that are required to operate the mobile station, as well as optionally providing mechanical vibration as a detectable output, as described below. The display can present any of a number of different displays, such as data and menus. The display can also display areas for softkey functions 121A and 121B that can be activated by depressing softkeys 120A and 120B, respectively. The user interface can also include a scroll element to scroll through menu items featured on the display. The scroll element can comprise any of a number of known devices that allow for scrolling through displayed items, including a rolling cylinder, ball or the like. In the illustrated embodiment, however, the scroll element comprises scroll keys 130.

The mobile station 10 also includes a user input interface, which allows the mobile station to receive data. In this regard, the user input interface can comprise any of a number of devices allowing the mobile station to receive data, such as a keypad 140, a touch display (not shown) or other input device such as voice input. In embodiments including a keypad, the keypad includes the conventional numeric (0-9) and related keys (#, *), and other keys used for operating the mobile station such as an INFO key 145, described below. In addition to the softkeys 120A and 120B, the other keys may include, for example, a SEND key, various menu scrolling keys and a PWR key.

Mobile station 10 can further include an infrared transceiver 150 or other means of local data transfer so that data can be shared with other devices such as other mobile stations, car guidance systems, personal computers, printers and the like. The local sharing of data, as well as the remote sharing of data, can also be provided according to a number of different techniques. For example, the mobile station may share data via a Radio Frequency Identification (RFID) transponder tag, as such is known to those skilled in the art. Additionally, or alternatively, the mobile station may share data using Bluetooth brand wireless technology developed by the Bluetooth Special Interest Group.

To store data upon receipt from the various sources, the mobile station includes volatile memory 180, such as volatile Random Access Memory (RAM) including a cache area for the temporary storage of data. The mobile station can also include non-volatile memory 160, which can be embedded and/or may be removable such as a removable Subscriber Identification Module (SIN). The non-volatile memory can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile station to implement the functions of the mobile station. For example, the memories, and particularly the non-volatile memory, can include a directory of names and associated location identifiers, such as mobile telephone numbers, landline telephone numbers, SMS numbers, pager numbers, facsimile numbers, and/or electronic mail (E-mail) addresses that may be entered into memory and thereafter accessed the user. The memories can also include software routines that control the operation of all or a portion of the controller 80 to thereby implement the present invention. The controller, which can include embedded cache memory, generates appropriate commands and controls the other component blocks of the mobile station.

In operation, in response to an event, such as an incoming call, a short message, a page or the like, the mobile station 10 receives an event alert, such as a call alert. For example, when the event comprises an incoming call, the base station 30 acts as an intermediary between a device calling the mobile station, such as a landline or mobile telephone, by sending a call alert to the mobile station, to which the controller responds by sending an output control signal to an output reproduction device 210. In response to, and based upon, the output control signal, the output reproduction device generates a detectable output, such as ring tones or other audible sounds, and/or mechanical vibration, light illumination of all or a portion of the mobile station or other detectable physical indications.

The output reproduction device can include any of a number of known devices within the mobile station 10, such as the ringer 95, a vibrating battery, a light source and/or any other device capable of providing a detectable output. Additionally, or alternatively, the output reproduction device can include any of a number of devices located at a distance form the mobile station, such as a remote audio system. In this regard, the output control signal can be transmitted from the mobile station via the infrared transceiver 150 or other means of data transfer (e.g., Bluetooth brand wireless technology). And upon receipt by the device located at a distance from the mobile station, the output reproduction device responds to the output control signal by generating the detectable output.

It will be appreciated that although as illustrated and described herein the controller 80 sends the output control signal directly to the output reproduction device, the mobile station 10 can include an event indicator, such as a call indicator, intermediate the controller and the output reproduction device. In such an instance, the controller sends the output control signal to the event indicator which, in turn, passes the output control signal to the output reproduction device. Further, the event indicator typically includes a sound generator that generates the ring tones according a predefined sequence in response to an event, such as an incoming call. The sequence of the ring tones is generally generated from the output control signal sent from the controller, which produces the output control signal by reading, from the memory 160, the ring tone or ring tone parameters stored therein. Thus, the output control signal contains the information for the sound generator of the event indicator defining the ring tone the sound generator generates for the output reproduction device 210.

The mobile station 10 is capable of being configured, such as by a user, to customize operation of the mobile station, as well as customize data stored in memory, such as non-volatile memory 160 and/or a removable SIM. In this regard, the user can configure a directory stored in memory to include at least one entry consisting of a name and one or more associated contact identifiers, as well as configure the controller 80 to speed dial a selected entry in the directory. Advantageously, the controller can also be configured to quick launch a text editor such that the user can enter a text message in the text editor and thereafter send the message to a predefined destination.

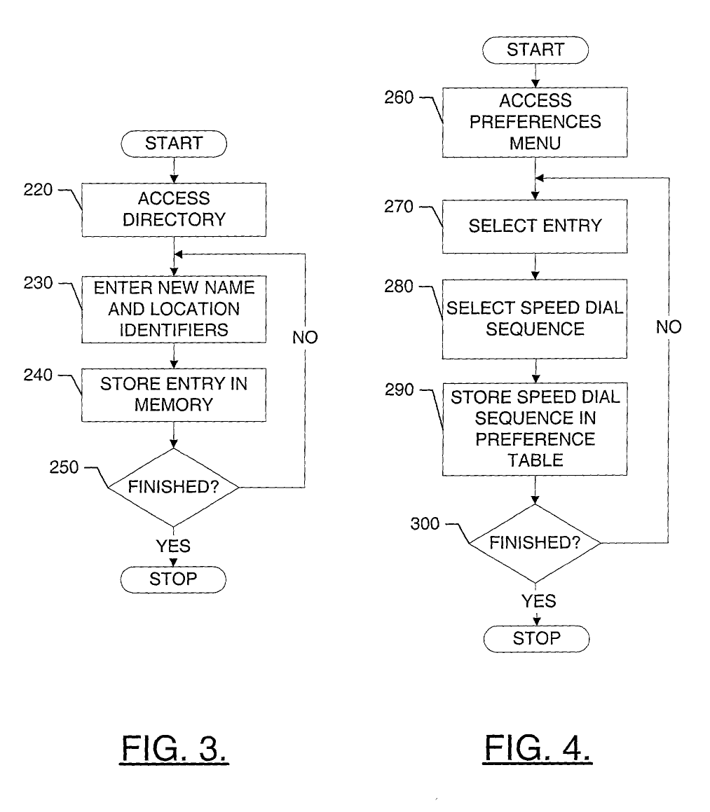

Referring to FIG. 3, the user can configure the directory of the mobile station 10 by entering names and associated location identifiers in the directory stored in memory, such as in non-volatile memory 160 or on a removable SIM. The names and contact identifiers can be entered and stored in any one of a number of manners but, according to one embodiment, the user first accesses the directory from a main menu, as shown in block 220. Thereafter, the user enters a name and contact numbers, for example “Mark” and 555 123 4567 respectively, as shown in block 230. As used herein, text such as names, location identifiers and text messages, can be entered into the mobile station 10 and, as such, received by the controller 80, in any one of a number of different manners. For example, the mobile station can receive the name and location identifiers via the keypad 140 on the user interface of the mobile station. In this regard, each character of the name and location identifiers can be produced through a specific key or as a combination of two or more keys. The name and location identifiers can, instead, be received via the softkeys 120A and 120B, and/or the scroll keys 130 by selecting the characters from a menu. The name and location identifiers can also be received via the infrared transceiver 150 or other means of local data transfer. Additionally, or alternatively, the name and location identifiers can be generated by voice recognition routines stored in memory in response to an audible input via the microphone 100, as such is known.

After the user enters the name and location identifiers of the entry, the controller 80 stores the entry in memory, such as in non-volatile memory 160 or a removable SIM, as illustrated in block 240. The user can then indicate whether the user desires to make more entries having different names and/or location identifiers, as shown in block 250. For example, the user can make one or more additional entries, such as one for a colleague from work, entered as “David”, and an entry for the user's bank manager, entered as “Bank Manager” having telephone numbers 555 876 5432 and 800 098 6789, respectively.

After saving the entries, the user can configure one or more entries for speed dialing, as such is known. The entries can be configured for speed dialing in any one of a number of manners but, according to one embodiment, referring to now to FIG. 4, the user first accesses a preference menu, as shown in block 260. Then, from the preference menu, the user can select a speed dialing menu. The user then selects a desired entry (e.g., “Mark”), and thereafter selects one or more keys on the keypad 140 to associate with the selected entry (e.g., (3) and (5)), hereinafter referred to as speed dialing keys associated with the selected entry, as illustrated in blocks 270 and 280. It will be appreciated that although the user can select one or more speed dialing keys to associate with the selected entry, the mobile station 10 can default one or more keys to associate with the function of speed dialing. For example, the mobile station can designate the key (*) as the function of speed dialing. In such an instance, to operate speed dial a selected entry, the user must press the designated key as well as the speed dialing keys associated with the selected entry.

After selecting the speed dialing keys, the speed dialing keys can be stored in a preference table held in memory, such as in non-volatile memory 160, as shown in block 290. After storing the speed dialing keys, then, the user can configure the other entries for speed dialing, if so desired, as illustrated in block 300. If the user desires to configure other entries for speed dialing, the user can repeat the process by first selecting another entry for which the user desires to configure speed dialing.

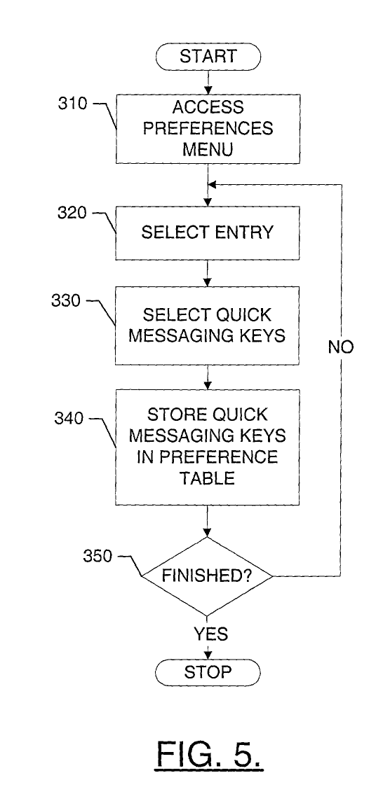

To improve the speed at which the mobile station 10 can be activated to execute a text editor and transmit a text message, the mobile station can configure one or more entries in the directory for quick messaging. The entries can be configured for quick messaging in any one of a number of manners but, according to one embodiment, referring to now to FIG. 5, the user first accesses the preference menu, as shown in block 310. Then, from the preference menu, the user can select a quick messaging menu. The user then selects a desired entry (e.g., “Mark”), and thereafter selects a one or more keys on the keypad 140 to associate with the selected entry (e.g., (3) and (5)), hereinafter referred to as quick messaging keys, as illustrated in blocks 320 and 330. As explained below, the mobile station of the present invention will therefore permit access to the text editor to compose a message to “Mark” merely by depressing (3) and (5).

To allow the user to compose text messages comprising text queries and thereafter receive a response based upon a search of the text query, the directory can include one or more entries associated with destination network elements, such as information processing elements 220 (e.g., personal computers, server computers or the like) that execute querying software routines, sometimes referred to as “bots.” The information processing elements can comprise any of a number of different processing elements but, in one embodiment, each information processing element executes a bot capable of searching a different query subject, such as geography, sports, stock markets, etc. Within the directory, the information processing elements can be identified by any of a number of different location identifiers, including a telephone number, SMS number or an Internet protocol (IP) address. In this regard, the user can configure the information processing elements for quick querying in a manner similar to configuring other entries in the directory for speed dialing and/or quick messaging. As used herein, then, one or more keys may be associated with each entry that identifies an information processing element, which such keys being referred to as quick query keys.

The quick messaging and quick query keys associated with respective entries can be selected in any one of a number of manners. It will be appreciated, however, that although the keys can be selected in any one of a number of manners, the entire sequence of keys, including any designated function keys or dedicated keys (described below), must differ for each speed dialing, quick messaging and quick querying sequence of keys across each entry in the directory. For example, if “Mark” has been associated with the sequence (*), (3) and (5) for speed dialing, no other entry in the directory can be associated with the sequence (*), (3) and (5) for speed dialing, quick messaging or quick querying. Like speed dialing, then, it will be appreciated that although the user can select one or more keys to associate with the selected entry to initiate quick messaging or quick querying, the mobile station 10 can be configured such that one or more keys are predefined to be associated with the function of quick messaging and/or quick querying. For example, the mobile station can designate the key (#) as the function of quick messaging. In such an instance, to activate the mobile station to send a quick message to a selected entry, the user must press the designated key (#) as well as the quick messaging key associated with the selected entry, e.g., (3) and (5) for “Mark.”

Additionally, or alternatively, the mobile station 10 can include one or more dedicated keys to associate with the function of quick messaging and/or quick querying. For example, the mobile station can include an INFO key 145 that, when depressed or otherwise actuated, activates the mobile station for quick querying of one or more designated information processing elements. For example, the INFO key can be associated with one information processing element such that the user can depress the INFO key, compose a text query and thereafter transmit the text query to the designated information processing element. Additionally, or alternatively, one or more dedicated keys can be associated with multiple entries such by depressing the dedicated key(s), a menu of entries will be presented from which the user can select a destination to which to send the text message. For example, the INFO key can be associated with a menu including all of the information processing elements such that the user can readily select the desired information processing element to which to send a text query.

As stated, in some instances a designated or dedicated key must be depressed to activate the function of speed dialing, quick messaging and/or quick querying before the speed dialing keys, quick messaging keys and/or quick query keys, respectively, are depressed. In such an instance, then, it will be appreciated that the speed dialing keys, quick messaging keys and/or quick query keys can include the same keys and or key combinations. For example, in one instance the key (*) can be designated to activate the speed dialing function, while the key (#) is designated to activate the quick messaging function. In such an instance, for example, for a user can either speed dial or transmit a text message to “Mark” by first depressing the key designated to activate the desired function (speed dialing or text messaging) and then depressing the keys associated with “Mark.” To activate speed dialing for “Mark,” then, the user must depress (*), (3) and (5). And to activate quick messaging for “Mark,” the user must depress (#), (3) and (5).

After selecting the quick messaging keys or quick querying keys, the respective keys can be stored in the preference table held in memory, such as in non-volatile memory 160, as shown in block 340. After storing the quick messaging keys or quick querying keys for the entry, then, the user can configure the other entries for quick messaging and/or quick querying, if so desired, as illustrated in block 350. If the user desires to configure other entries for quick messaging and/or quick querying, the user can repeat the process by first selecting another entry for which the user desires to configure quick messaging or quick querying.

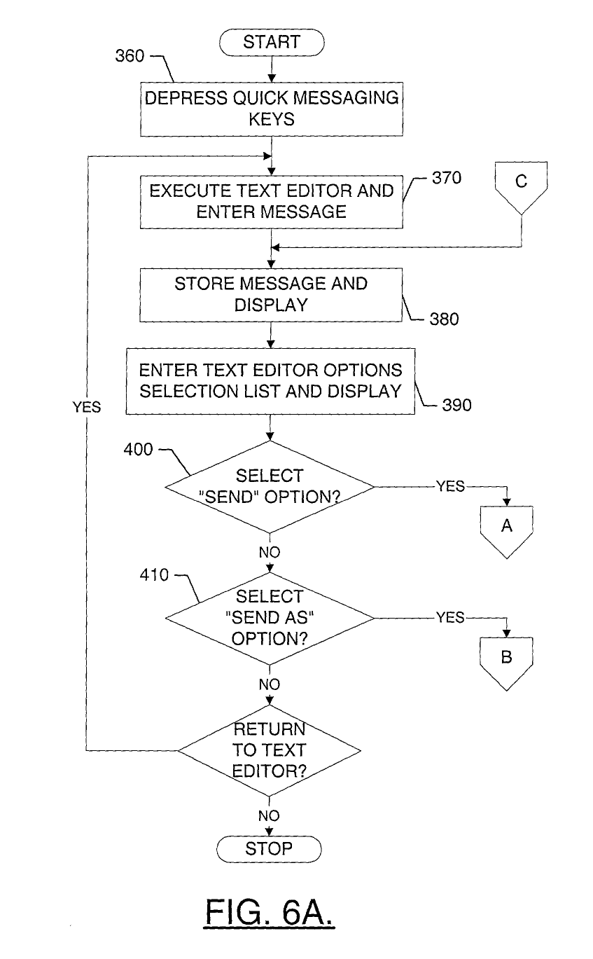

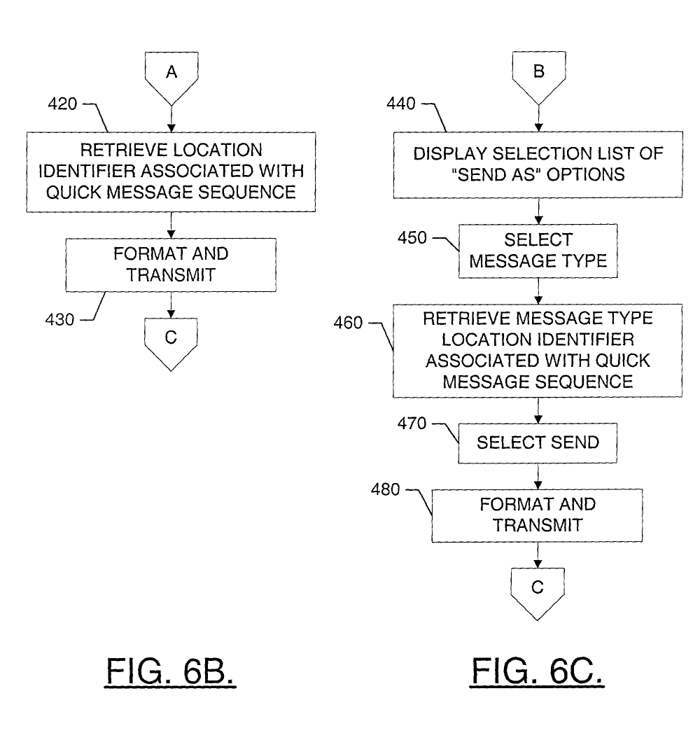

After storing the quick messaging keys for one or more entries, the mobile station can be activated to receive and thereafter transmit a text message to a selected entry upon depressing or otherwise actuating the respective quick messaging keys. Referring to FIGS. 6A-6C, in operation, a method of transmitting a text message from the mobile station 10 utilizing the quick messaging keys begins by depressing or otherwise actuating key(s) that activate the quick messaging function then depressing or otherwise actuating the quick messaging keys associated with an entry to whom the user desires to send a text message, shown in block 360. For example, using the entry “Mark” described above, the method begins by depressing (#) key to activate the quick messaging function and then depressing the quick messaging keys (3) and (5) on the keypad 140. Upon depressing the quick messaging keys associated with the desired entry, the controller 80 causes the mobile station to enter a text origination mode and a corresponding text origination/editor menu function. In the text origination/editor menu function, controller executes a text editor, which is thereafter displayed by the display 110, as shown in block 370. The text editor, in turn, prompts the user to enter a text message into the text editor. Additionally, the text editor can prompt the user to select, if desired, a text editor options selection list menu function. For example, the mobile station can prompt the user to enter a text message into the mobile station by presenting a text editor including a blinking cursor on the display, and can simultaneously prompt the user to select the text editor options selection list menu function 121 by presenting a softkey function, such as “option,” on a portion of the display.

The text message can be entered and received in any one of a number of different manners as described above. As shown in block 380, after the text message has been received by the mobile station 10, the controller 80 can save text message into memory, such as non-volatile memory 160, so that the text message can be subsequently transmitted to the desired entry associated with the quick messaging keys previously depressed, e.g., “Mark.” It will be appreciated, however, that the stored message need not be entered by the user, but could instead, for example, have been previously received by the mobile station, such as from the infrared transceiver 150, and stored into memory, such as non-volatile memory 160, in which case the message is being forwarded to the desired entry. For example, in response to execution of the text editor, the user can respond by operating the keypad 140 so as to request that the previously received message be retrieved from memory. In this case, the mobile station responds to the user's request by retrieving the message from memory and thereafter by presenting the retrieved message on the display 110. The user can then edit the message, if desired, by any of the aforementioned methods of entering text into the mobile station.

After saving the text message (or retrieving/editing a previously saved message), the user can send the message and/or specify a message type by first operating the mobile station 10 (e.g., by depressing one or more predetermined keys of keypad 140) so as to specify that the mobile station enter the text editor options selection list menu function, as shown in block 390. For example, the user may specify that the text editor options selection list menu function be entered by depressing a softkey 120 of the keypad 140 located beneath the softkey function 121 “option” appearing on display 110. The mobile station then responds by entering the text editor options selection list menu function.

In response to entering the text editor options selection list menu function, the mobile station 10 displays a text editor options selection list (also referred to as an “options selection list”) to the user via display 110, and awaits the depression of one or more keys of keypad 140 by the user specifying that one of the displayed options of the list is selected. The options selection list includes various user-selectable options, one of which, upon selection by the user, enables the user to send the text message to the desired entry, and another that enables the user to specify an eventual message type for a the text message prior to transmitting the text message, as will be described below. In this regard, among various other options, the options selection list can include a “send” option and a “send as” option. Also, in addition to presenting the options selection list on the display, the mobile station can present an option for returning to the text origination/editor menu function, such as can be represented by the softkey function 121 represented by the word “Back.”

As one of the options available to the user under the text origination/editor menu function, the “send” option enables the user to specify that the text message stored in memory be transmitted from the mobile station 10. Assuming that the mobile station is presenting the options selection list on the display 110, then the user may specify that the text message be transmitted by first depressing predetermined keys of keypad 140 so as to specify that the “send” option is selected, such as a SEND key 147 designated by an illustration of a telephone receiver, as shown in block 400. The mobile station can then respond in any one of a number of different manners to thereby transmit the text message. According to one advantageous embodiment, the controller 80 of the mobile station responds to selection of the “send” option by first retrieving a location identifier (e.g., SMS number) for the desired entry associated with the quick messaging keys previously depressed, e.g., the SMS number for “Mark,” as shown in block 410 of FIG. 6B. By retrieving the location identifier, then, the mobile station identifies the destination user terminal to which the user desires the text message to be sent.

The location identifier can be any of the location identifiers of the respective entry. In this regard, the location identifier can be designated as the location identifier associated with a type of message the user typically sends the entry, such as an SMS number for sending SMS messages to the entry, or an E-mail address for sending E-mail messages to the entry. As such, by designating the location identifier to be that associated with a message type, the user can designate the type of message to send to the entry, i.e., an E-mail or an SMS message. This type of designation is in contrast to designating a type of message using the “send as” option, described below. If the user chooses to not designate the type of the location identifier, however, the controller can assign a default type to the location identifier with the default type being designated to be an SMS message in one embodiment.

After the controller 80 of the mobile station 10 has retrieved the location identifier, the controller retrieves the stored text message. The controller then formats the retrieved text message in accordance with, for example, the current version of the IS-136 wireless communication protocol, in order to compose an SMS message. Thereafter, the mobile station transmits the text message to the base station 30 of the BMI 40, as shown in block 430. And from the base station, the SMS message is transmitted to the MSC 50, from where the message is eventually forwarded to the destination terminal. Following transmission of the text message, the mobile station can again present the text message stored in memory on the display 110.

In addition to sending the text message as an SMS message to the destination terminal, the mobile station 10 has a capability for enabling the user to specify an eventual message type for the text message prior to transmitting the text message. More particularly, for example, the mobile station has a capability for enabling the user to specify that an SMS message transmitted from the mobile station to the BMI 40 be converted by the MC 35 to another, selected message type (e.g., a facsimile message, an electronic mail message, or a page message), before being forwarded by the MC through the MSC 50 to the destination terminal. The manner in which this aspect of the invention is performed will also be described below.

As previously stated, one of the options available to the user under the text origination/editor menu function is a “send as” option. The user may elect to select this option for a case in which, for example, the user desires that an SMS message transmitted from the mobile station 10 to the BMI 40 be converted by the MC 35 of the BMI to either a facsimile message, an E-mail message, or a page message, before being forwarded to an appropriate destination terminal, such as a destination facsimile device, a processing element (e.g., personal computer), or pager, respectively. Assuming that the user desires to select the “send as” option in response to the mobile station presenting the options selection list on the display 110, the user may select the “send as” option by depressing one or more predetermined keys of keypad 140, as shown in block 410 of FIG. 6A.

After the user selects the “send as” option, the mobile station 10 presents on the display 110 a list of “send as type” options, as illustrated in block 440 of FIG. 6C. According to a preferred embodiment of the invention, this list includes a “send E-mail” option, a “send page” option, a “send instant message” option, and a “send facsimile (fax)” option. Also, the mobile station can present on the display an option for returning to the text origination/editor menu function, such as can be represented by the softkey function 121 identified by the word “Back.” It will be appreciated that the desired entry associated with the quick messaging keys previously depressed may not include a location identifier associated with one or more of the foregoing options. For example, one entry may include an SMS number for sending an SMS message, but not include an E-mail address for transmitting an E-mail message to a processing element. In such an instance, the controller can include logic to thereby prevent the user from selecting the options of the list for which the respective entry does not include a location identifier, such as by masking the respective options. Alternatively, the display can present all of the options, with the controller prompting the user for a location identifier for a selected option if the entry does not already include an appropriate location identifier, as described below.

For example, according to one case, the user desires that the text message be converted by the MC 35 from an SMS message to an E-mail message. It will be appreciated that although the following case will be described in the context of converting an SMS message to an E-mail message, the following description can equally apply to any case where the user desires that the text message be converted from one type of message to another type of message by the MC. In the case where the user desires the SMS message to be converted into an E-mail message, the user can specify that the message be converted to an E-mail message by depressing one or more predetermined keys of keypad 140 so as to select the message type “send E-mail” option, such as by scrolling through the list using scroll keys 130 and thereafter depressing a predetermined key of the keypad, as shown in block 450.

In response to the user selecting the “send E-mail” option, the controller 80 of the mobile station 10 responds by retrieving the E-mail address for the desired entry associated with the quick messaging keys previously depressed, as illustrated in block 460. If the desired entry does not include an E-mail address, the mobile station can respond by presenting a message on the display 110 to prompt the user to enter an E-mail address for the respective entry into the mobile station. The controller, in turn, monitors the output of keypad 140 for a user-specified E-mail address, which the user can enter in any one of a number of different manners, as described above. After the user enters the user-specified E-mail address, the controller 80 preferably stores the entered address with the respective entry into memory, such as non-volatile memory 160. It will be appreciated, however, that the controller need not store the user-specified E-mail address for operation of the present invention.

After the controller 80 retrieves the E-mail address, or after the controller stores the user-specified E-mail address, the user can operate the keypad 140 of the mobile station 10 so as to specify that the text message be transmitted to the BMI 40, such as by depressing the SEND key 147, as shown in block 470. The controller then responds by retrieving the stored text message and E-mail address (if so stored) from memory, and thereafter formats all of the retrieved information in accordance with, for example, the current version of IS-136, in order to compose an SMS message. The mobile station then transmits the text message to the base station 30 in a similar manner as described above, as illustrated in block 480. The SMS message transmitted, however, includes information specifying that the SMS message be converted to an E-mail message by the MC 35 before being forwarding to the destination processing element.

As previously stated, another option that is available to the user while the mobile station 10 displays the list of “send as” options includes an option for returning to the text origination/editor menu function. The user may select this option at any time while the list of “send as” options is presented by the display 110. For example, the user can elect to return to the text origination/editor menu function after having selected one or more of the “send E-mail,” “send page,” “send instant message” and “send fax” options, or without having selected any one of these options. The user may select the option for returning to the text origination/editor menu function by depressing one or more predetermined keys of the keypad 140, in which case the mobile station responds by returning control back to the text origination/editor menu function.

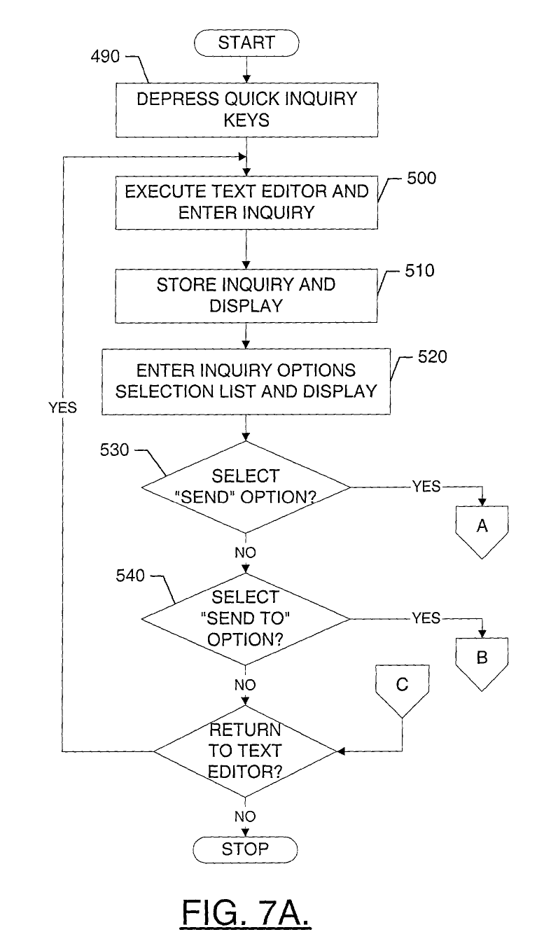

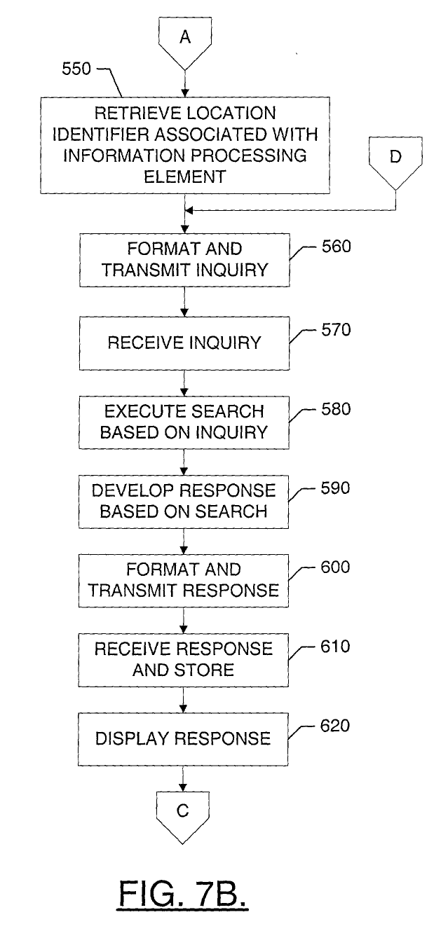

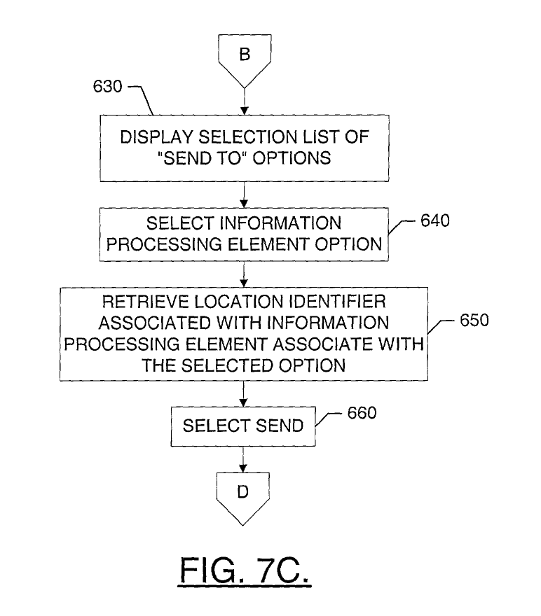

To allow the user to compose text messages comprising text queries and thereafter receive a response based upon a search initiated by the text query, the directory can include one or more entries associated with information processing elements (e.g., processing elements 220). As also stated, the user can configure the information processing elements for quick querying by associating quick query keys with one or more information processing elements. In operation, then, referring to FIGS. 7A-7C, a method of transmitting a text query from the mobile station 10 utilizing the quick query keys begins by depressing or otherwise actuating key(s) that activate the quick querying function and then depressing or otherwise actuating the quick query keys associated with an information processing element, shown in block 490. The information processing elements associated with the quick query keys can comprise any of a number of different processing elements that execute querying software routines, sometimes referred to as “bots,” that search one or more databases 230 based upon a query.

The mobile station can include one primary information processing element associated with one or more primary quick query keys that generally allow the user to transmit a quick query without specifying or otherwise selecting any particular information processing element. For example the primary information processing element can be associated with the primary quick query keys comprising a dedicated key, such as the INFO key 145 of the keypad 140. In such an instance, the primary information processing element associated with the dedicated key will typically be capable of executing a bot capable of searching a text query independent of the subject of the text query. Additionally, or alternatively, different quick query keys can be associated with different information processing elements executing different bots, with the bots capable of searching text queries dependent upon the subject of the query, such as geography, sports, stock markets, etc. For example, in such an instance, each quick query key can be associated with multiple information processing elements, and/or the user can be presented with a “send to” option to designate the information processing element to which the text query will be transmitted, as described below.

Upon depressing the quick query keys associated with the information processing element 220, the controller 80 causes the mobile station 10 to enter a query origination mode and a corresponding query origination/editor menu function. In the query origination/editor menu function, the controller executes a text editor, such as the text editor executed in response to depressing the quick messaging keys, which is thereafter displayed by the display 110, as shown in block 500. The text editor, in turn, prompts the user to enter a text query into the text editor. Additionally, the text editor can prompt the user to select, if desired, a query options selection list menu function. For example, the mobile station can prompt the user to enter a text query into the mobile station by presenting a text editor including a blinking cursor on the display, and can simultaneously prompt the user to select the query editor options selection list menu function by presenting the a softkey function, such as “option,” on a portion of the display.

The text query can be entered and received in any one of a number of different manners as described above. As shown in block 510, after the text query has been received by the mobile station, the controller 80 can save the text query into memory, such as into non-volatile memory 160, so that the text query can be subsequently transmitted to the respective information processing element 220 associated with the quick messaging keys previously depressed. It should be noted, however, that, just as in the case of quick messaging, the stored query need not be entered by the user, but could instead, for example, have been previously received by the mobile station 10, such as from the infrared transceiver 150, and stored into memory, such as non-volatile memory 160, in which case the message is being forwarded to the information processing element with the quick query keys previously depressed.

After saving the text query (or retrieving/editing a previously saved query), the user can send the query and/or specify an information processing element 220 to which to send the message by first operating the mobile station 10 (e.g., by depressing one or more predetermined keys of keypad 140) so as to specify that the mobile station enter the query options selection list menu function, as shown in block 520. For example, the user may specify that the query editor options selection list menu function be entered by depressing a softkey 120 of keypad 140 located beneath the softkey function 121 “option” appearing on display 110. The mobile station then responds by entering the query options selection list menu function.

In response to the mobile station 10 entering the query options selection list menu function, the mobile station displays a query options selection list (also referred to as an “options selection list”) to the user via display 110, and awaits the depression of one or more keys of keypad 140 by the user specifying that one of the displayed options of the list is selected. The options selection list includes various user-selectable options, one of which, upon selection by the user, enables the user to send the text query to the information processing element associated with the quick querying keys previously depressed, and another that enables the user to specify an information processing element to send the query to, as will be described below. In this regard, among various other options, the options selection list can include a “send” option and a “send to” option. Also, in addition to presenting the options selection list on the display, the mobile station can present an option for returning to the query origination/editor menu function, such as can be represented by the softkey function 121 represented by the word “Back.”

One of the options available to the user under the query origination/editor menu function, the “send” option enables the user to specify that the text query stored in memory be transmitted from the mobile station 10. Assuming that the mobile station is presenting the options selection list on the display 110, then the user may specify that the text query be transmitted by first depressing predetermined keys of keypad 140 so as to specify that the “send” option is selected, such as a SEND key 147 designated by an illustration of a telephone receiver, as shown in block 530. The mobile station can then respond in any one of a number of different manners to thereby transmit the text query. According to one advantageous embodiment, the controller 80 of the mobile station responds to selection of the “send” option by first retrieving a location identifier (e.g., IP address) for the information processing element 220 associated with the quick query keys previously depressed, as shown in block 550 of FIG. 7B. As before, the location identifier can be any of the location identifiers of the respective information processing element. But in embodiments where the information processing element is connected to the BMI 40 across a WAN, such as the Internet, the location identifier is preferably the IP address of the information processing element.

After the controller 80 of the mobile station 10 has retrieved the location identifier, the controller retrieves the stored text query. The controller then formats the retrieved text query in accordance with, for example, the current version of the IS-136 wireless communication protocol, in order to compose the text query in the form of an SMS query. Thereafter, the mobile station transmits the text query to the base station 30 of the BMI 40, as shown in block 560. And from the base station, the SMS message is transmitted to the MSC 50, from where the query is eventually forwarded to one or more information processing elements 220, such as via the WAN 227 through the GTW 225, as shown in block 570. Following transmission of the text query, the mobile station can again present the text query stored in memory on the display 110.

Upon receipt of the text query, the information processing elements 220 execute respective bots to thereby perform searches of at least one database 230 based upon the text query, as shown in block 580. In this regard, the databases can be co-located with the respective information processing elements (as illustrated), or remote from the information processing elements, such as across the WAN 227. The bots can search the databases in any one of a number of known manners but, in one embodiment, the bots search the databases based upon at least one keyword in the query that identifies a subject of the query. For example, should the text query include the following question, “What is the definition of pizza?,” the bots could search the databases based upon the keyword “pizza” that identifies the subject. Alternatively, the bots could recognize the keyword “pizza” corresponds to a subject of “food,” and accordingly search the subject “food.”

Based upon the search performed by the bots, the information processing elements 220 can develop responses to the text query, as shown in block 590. The responses can include any of a number of different types of responses, including a text response, a pictorial response, an audible response or the like. From the responses, then, the information processing elements format the responses in accordance with, for example, the current version of the IS-136 wireless communication protocol, and thereafter transmit the responses through the WAN 227 and GTW 225 to the BMI 40, which thereafter forwards the response to the mobile station 10 via the base station 30, as shown in block 600.

Upon receipt of the responses, the mobile station 10 can store the responses into memory, such as non-volatile memory 160, as illustrated in block 610. The responses can be stored in addition to the previously stored text query or, as in one embodiment, the responses can be stored by writing the responses over the text query in memory. In addition to, or in lieu of, storing the responses, the mobile station can present the responses on the display 110, as shown in block 620. In this regard, if the responses include responses from multiple information processing elements 220, the mobile station can present the responses as a collective response and, if desired, include a response identifier associated with the response from each information processing element. The response identifier can include any of a number of different pieces of information, including the source(s) of the respective portion of the collective response (e.g., the information processing element and/or databases), a determined percent relevance of the respective portion relative to the text query, and/or one or more keywords from the respective portion of the relative to the text query (e.g., highlighting keywords form the text query in the response). For example, a response to the text query “What is the definition of pizza?” might include the following:

Definition of pizza provided by The American Heritage® Dictionary of the English Language, Fourth Edition, Copyright © 2000 by Houghton Mifflin Company

### Noun

A baked pie of Italian origin consisting of a shallow breadlike crust covered with seasoned tomato sauce, cheese, and often other toppings, such as sausage or olives.

### Etymology

Italian, pie, tart, pizza.

In lieu of presenting all of the responses collectively, the mobile station can present the user with a listing of each response including the response identifier, from which the user can select to display one or more responses.

As stated, the user can specify the information processing elements 220 to which to send the text query, such as via a “send to” option. In this regard, the mobile station 10 has a capability for enabling the user to specify one or more processing elements to which to send the text query. More particularly, for example, the mobile station has a capability for enabling the user to specify that the text query be sent to an information processing element 220 executing a bot capable of searching text queries based upon a subject, such as geography, sports, stock markets, etc. Assuming that the user desires to select the “send to” option in response to the mobile station presenting the options selection list on the display 110, then, the user may select the “send to” option by depressing one or more predetermined keys of keypad 140, as shown in block 540 of FIG. 7A.

After the user selects the “send to” option, the mobile station 10 presents on the display 110 a list of “subject” options, as illustrated in block 630 of FIG. 7C. For example, the subject options list can include subjects such as “geography,”“sports,” “stock markets,” etc. Also, the mobile station can present on the display an option for returning to the query origination/editor menu function, such as can be represented by the softkey function 121 represented by the word “Back.” For example, according to one case, the user desires that the text query be transmitted to an information processing element 220 executing a bot capable of searching sports queries. It will be appreciated that although the following case will be described in the context of an information processing element executing a bot capable of searching sports queries, the following description can equally apply to any case where the user desires that the text query be sent to a specific information processing element, whether the respective bot searches sports queries or queries in any other subject, or whether the user merely desires to send the text query to a specific information processing element.

In the case where the user desires to send the text query to an information processing element 220 executing a bot capable of searching sports queries, the user can specify that the message be sent to the respective information processing element by depressing one or more predetermined keys of keypad 140 so as to select the message type “sports” option, such as by scrolling through the list using scroll keys 130 and thereafter depressing a predetermined key of the keypad, as shown in block 640. In response to the user selecting the “sports” option, the controller 80 of the mobile station 10 responds by retrieving the location identifier (e.g., IP address) for the information processing element associated with the “sports” option, as illustrated in block 650. After the controller retrieves the location identifier, the user can operate the keypad of the mobile station so as to specify that the text query be transmitted to the selected information processing element via the BMI 40, as shown in block 660. As before in the context of the “send” option, the controller then retrieves the stored text query and location identifier from memory, and thereafter formats and transmits the text query, as illustrated in block 560 of FIG. 7B. The respective information processing element then receives the text query and, as before executes the bot to search the databases based upon the text query to thereafter develop, format and transmit a response to the mobile station, which thereafter stores and/or displays the response, as shown in blocks 570 to 620 of FIG. 7B.

Therefore, the present invention provides an improved system, mobile station and method of transmitting a text message from a mobile station. By enabling the mobile station to facilitate composing and transmitting a text message to a specified entry in the directory, the text message can be composed and transmitted without separately entering or searching for a location identifier to which to send the text message, and without separately searching for the text editor among the various features of the mobile station. As such, the number of keys that must be actuated to activate the text editor and to send the resulting text message is reduced. Moreover, when the entry includes an information processing element, the mobile station facilitates composing and transmitting a text query to the information processing element, and subsequently receives a response from the information processing element. As such, the mobile station can facilitate a user in composing a text query and transmitting the text query without requiring the query to be transmitted via slow WAP network interconnection speeds, and without requiring use of the clumsy user interfaces of many WAP browsers.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A terminal adapted to communicate via a communications system, wherein the terminal comprises:
a keypad including a plurality of keys, wherein at least one key is associated with at least one directory entry that includes at least one location identifier;
a controller capable of executing a text editor in response to actuation of the at least one key, wherein said controller is capable of receiving a text message into the text editor; and
a transmitter capable of transmitting the text message to a destination identified by the location identifier of the at least one entry associated with the at least one key.

2. A terminal according to claim 1 further comprising a memory having a directory stored therein, wherein the directory includes a plurality of entries.

3. A terminal according to claim 1, wherein at least one key is associated with at least one information processing element, wherein said controller is capable of receiving a text query in the text editor in response to actuation of the at least one key associated with an information processing element, wherein said transmitter is capable of transmitting the text query to the information processing element associated with the at least one key.

4. A terminal according to claim 3 further comprising a receiver capable of receiving a response based upon the text query transmitted to the information processing element.

5. A terminal according to claim 3, wherein the text query includes at least one key word identifying a subject, wherein said transmitter is capable of transmitting the text query to at least one information processing element based upon the subject identified by the at least one key word.

6. A terminal according to claim 1, wherein said controller is capable of permitting selection of a type of text message to be transmitted.

7. A terminal according to claim 6, wherein said controller is capable of permitting the selection of the type of text message from the group consisting of a short message, a facsimile message, an instant message and an E-mail message.

8. A terminal according to claim 1 further comprising a display capable of displaying the text editor executed by said controller, wherein the display is also capable of displaying the text message.

9. A terminal adapted to communicate via a communications system, wherein the terminal comprises:
a keypad including a plurality of keys, wherein at least one key is associated with at least one information processing element;
a controller capable of executing a text editor in response to actuation of the at least one key, wherein said controller is capable of receiving a text query into the text editor; and
a transmitter capable of transmitting the text query to the at least one information processing element associated with the at least one key.

10. A terminal according to claim 9 further comprising a receiver capable of receiving a response based upon the text query transmitted to the information processing element.

11. A terminal according to claim 9, wherein said controller is capable of permitting selection of at least one information processing element to which the text query is transmitted.

12. A terminal according to claim 9, wherein the text query includes at least one key word identifying a subject, and wherein said transmitter is capable of transmitting the text query to at least one information processing element based upon the subject identified by the at least one key word.

13. A terminal according to claim 9 further comprising a display capable of displaying the text editor executed by said controller, wherein the display is also capable of displaying the text query.

14. A communications system comprising:
a communications network comprising at least one terminal for communication, wherein at least one terminal includes:
a keypad having at least one key, wherein at least one key is associated with at least one directory entry that includes at least one location identifier;
a controller capable of receiving a text message in response to actuation of the at least one key; and
a transmitter capable of transmitting the text message in accordance with the location identifier of the at least one entry associated with the at least one key; and
a destination network element positioned within said communications network in accordance with the location identifier of the at least one entry and capable of receiving the text message.

15. A communications system according to claim 14, wherein said controller is capable of receiving a text query and said transmitter is capable of transmitting the text query, and wherein said destination network element comprises a least one information processing element for executing a search of at least one database based upon the text query.

16. A communications system according to claim 15, wherein the at least one terminal further includes a receiver capable of receiving a response from said information processing element.

17. A communications system according to claim 14, wherein the text query includes at least one key word identifying a subject, wherein the transmitter of said terminal is capable of transmitting the text query to at least one information processing element based upon the subject identified by the at least one key word.

18. A communications system according to claim 14, wherein said controller is capable of permitting selection of a type of text message to be transmitted.

19. A communications system according to claim 18, wherein said controller is capable of permitting the selection of the type of text message from the group consisting of a short message, a facsimile message, an instant message and an E-mail message.

20. A method of transmitting a text message from a terminal adapted to communicate via a communications system, wherein the terminal includes a keypad including a plurality of keys, said method comprising:
actuating at least one key, wherein the at least one key is associated with at least one directory entry that includes at least one location identifier;
executing a text editor in response to actuation of the at least one key;
receiving a text message into the text editor; and
transmitting the text message to a destination identified by the location identifier of the at least one entry associated with the at least one key.

21. A method according to claim 20, wherein the at least one key is associated with an information processing element, wherein receiving a text message comprises receiving a text query into the text editor, wherein transmitting comprises transmitting the text query to the information processing element associated with the at least one key.

22. A method according to claim 21 further comprising receiving a response based upon the text query transmitted to the information processing element.

23. A method according to claim 22 further comprising:
searching of at least one database based upon the text query; and
developing the response based upon the text message and the search, wherein executing the search and developing the response occur after transmitting the text query to the information processing element.

24. A method according to claim 23, wherein receiving a text message comprises receiving a text message including at least one key word identifying a subject, wherein transmitting the text message comprises transmitting the text message to at least one information processing element based upon the subject identified by the at least one key word.

25. A method according to claim 20 further comprising selecting a type of text message before transmitting the text message.

26. A method according to claim 25, wherein selecting a type of text message comprises selecting the type of text message from the group consisting of a short message, a facsimile message, an instant message and an E-mail message.
